(19) United States
(12) Patent Application Publication
(10) Pub. No.: US 2016/0082915 A1
(43) Pub. Date: Mar. 24, 2016

(54) Vehicle Safety Seat

(71) Applicant: Stephen Madaras, North Hampton, NH (US)

(72) Inventor: Stephen Madaras, North Hampton, NH (US)

(21) Appl. No.: 14/816,544

(22) Filed: Aug. 3, 2015

Related U.S. Application Data
(60) Provisional application No. 62/031,980, filed on Aug. 1, 2014.

(51) Int. Cl. B60R 21/207; B60N 2/427; B60N 2/54; B60N 2/42

(52) U.S. Cl. CPC B60R 21/207; B60N 2/43; B60N 2/42781; B60N 2/548; B60N 2/42736; B60R 2021/01013

(57) ABSTRACT

A vehicle safety seat for protecting a vehicle occupant from airborne debris and serious injury in the event of an accident. The vehicle safety seat includes a seat having a seat bottom, a backrest, and a headrest, wherein the seat is pivotally secured to a frame. The frame is secured to a floor of a vehicle so as to allow the seat to recline upon collision in order to absorb inertial forces resulting from impact with another object. The safety seat further includes one or more airbags disposed on each of the lateral sides of the seat bottom, the backrest, and the headrest. The airbags are operably connected to an inflator that inflates and deploys the airbags upon detection of a signal output via one or more sensors. The sensors can detect a pending collision between the vehicle and another object.

### CROSS REFERENCE TO RELATED APPLICATION

This application claims the benefit of U.S. Provisional Application No. 62/031,980 filed on Aug. 1, 2014. The above identified patent application is herein incorporated by reference in its entirety to provide continuity of disclosure.

### BACKGROUND OF THE INVENTION

### Field of the Invention

The present invention relates to vehicle passenger safety devices. More specifically, the present invention provides a vehicle safety seat comprising a seat bottom, a backrest, and a headrest, wherein the seat is pivotally secured to a frame. The frame is secured to a floor of a vehicle so as to allow the seat to recline upon collision in order to absorb inertial forces resulting from impact with another object. One or more airbags are housed in the seat and are adapted to deploy in the event of an accident, wherein the airbags enclose a user seated in the seat in order to protect the user from airborne debris.

Many individuals use transportation, including cars and buses, in order to get from one place to another. However, these modes of transportation can pose dangerous risks and cause serious injuries to passengers upon impact with another object. Passengers may be thrown from the vehicle or may suffer injuries to their person as a result of impact from airborne debris, such as broken glass and objects stored on the interior of the vehicle. Furthermore, rigid seats cause injury, such as immediate or delayed neck and back pain, upon collision due to the force of impact thrusted upon one's body. Therefore, there exists a need in the prior art for a safety seat that can recline and deploy airbags in the event of a collision in order to protect the user's body from injuries.

Devices have been disclosed in the prior art that relate to safety seats. These include devices that have been patented and published in patent application publications. These devices generally relate to a seat having a frame pivotally secured to a vehicle or portions of the seat are pivotally secured to one another so as to allow the entire seat or portions of the seat to tilt backwards, such as U.S. Pat. No. 8,297,698, U.S. Pat. No. 8,240,736, U.S. Pat. No. 5,636,424, U.S. Pat. No. 5,605,372, and U.S. Pat. No. 6,416,127. Other devices generally relate to an arm restraint net or shroud secured to an aircraft seat adapted to deploy and cover a pilot's arms upon ejection from the aircraft, such as U.S. Pat. No. 5,415,366 and U.S. Pat. No. 4,215,835.

These prior art devices have several known drawbacks. The devices in the prior art fail to provide a vehicle safety seat that reclines upon collision and includes airbags adapted to deploy from the seat in order to protect a user from airborne debris. Some devices include chairs adapted to recline backwards upon collision, however, such chairs fail to comprise an airbag therein. Other devices include a seat having a restraint system disposed thereon and adapted to extend over a user's arms, however, the restraint system fails to deploy airbags configured to prevent debris from injuring a user positioned on the seat. Thus, the prior art devices fail to disclose a vehicle safety seat capable of reducing injury to a user upon collision via an automatically reclining seat that deploys airbags from the lateral sides thereof.

In light of the devices disclosed in the prior art, it is submitted that the present invention substantially diverges in design elements from the prior art and consequently it is clear that there is a need in the art for an improvement to existing vehicle safety seats. In this regard the instant invention substantially fulfills these needs.

### SUMMARY OF THE INVENTION

In view of the foregoing disadvantages inherent in the known types of vehicle safety seats now present in the prior art, the present invention provides a new vehicle safety seat wherein the same can be utilized for providing convenience for the user when seated in a vehicle during a collision.

It is therefore an object of the present invention to provide a new and improved vehicle safety seat that has all of the advantages of the prior art and none of the disadvantages.

It is another object of the present invention to provide a vehicle safety seat comprising a seat having a seat bottom, a backrest, and a headrest, wherein the seat is adapted to be secured in a vehicle.

Another object of the present invention is to provide a vehicle safety seat further comprising one or more airbags, wherein a pair of airbags are disposed on opposing lateral sides of the seat bottom, the backrest, and the headrest.

Yet another object of the present invention is to provide a vehicle safety seat further comprising one or more sensors adapted to detect a collision and generate a signal to an airbag inflator adapted to inflate the airbags, wherein the airbags enclose a user seated upon the seat in order to protect the user from airborne debris.

Yet another object of the present invention is to provide a vehicle safety seat further comprising a frame pivotally secured to the seat and adapted to affix the seat to a vehicle so as to allow the seat to recline upon collision in order to absorb inertial forces resulting from impact with another object.

Another object of the present invention is to provide a vehicle safety seat that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of an embodiment of the vehicle safety seat wherein the seat is in an upright position and the airbags are disposed in a stored configuration.

FIG. 2 shows a perspective view of an embodiment of the vehicle safety seat wherein the seat is in a reclined position and the airbags are disposed are deployed.

FIG. 3 shows a diagram of the control circuit of the vehicle safety seat.

### DETAILED DESCRIPTION OF THE INVENTION

Reference is made herein to the attached drawings. Like reference numerals are used throughout the drawings to depict like or similar elements of the vehicle safety seat. For the purposes of presenting a brief and clear description of the present invention, the preferred embodiment will be discussed as used for protecting a user by preventing airborne debris from injuring the user during a vehicle collision. The figures are intended for representative purposes only and should not be considered to be limiting in any respect.

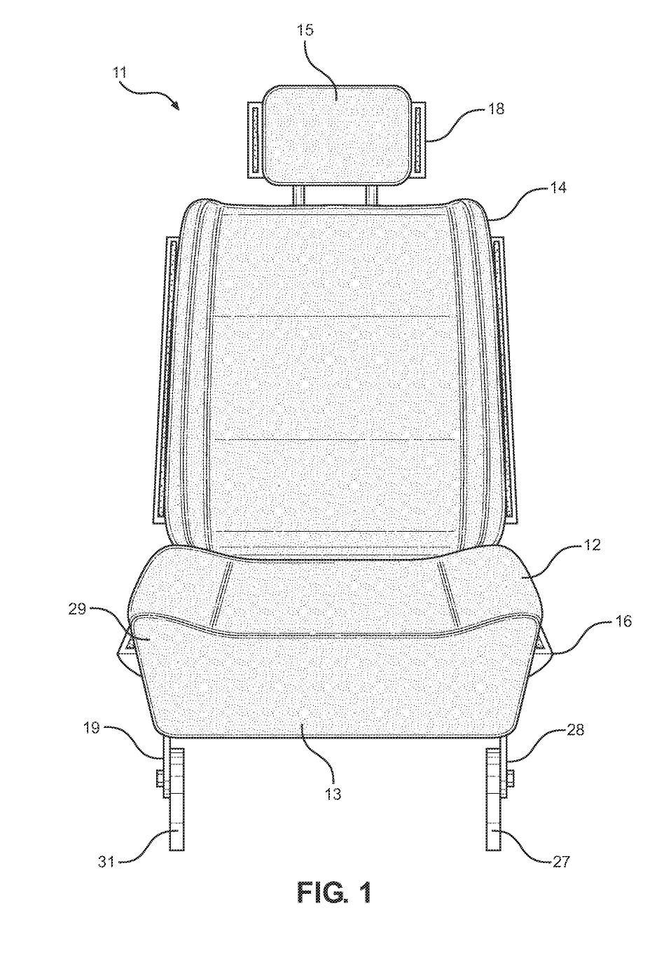

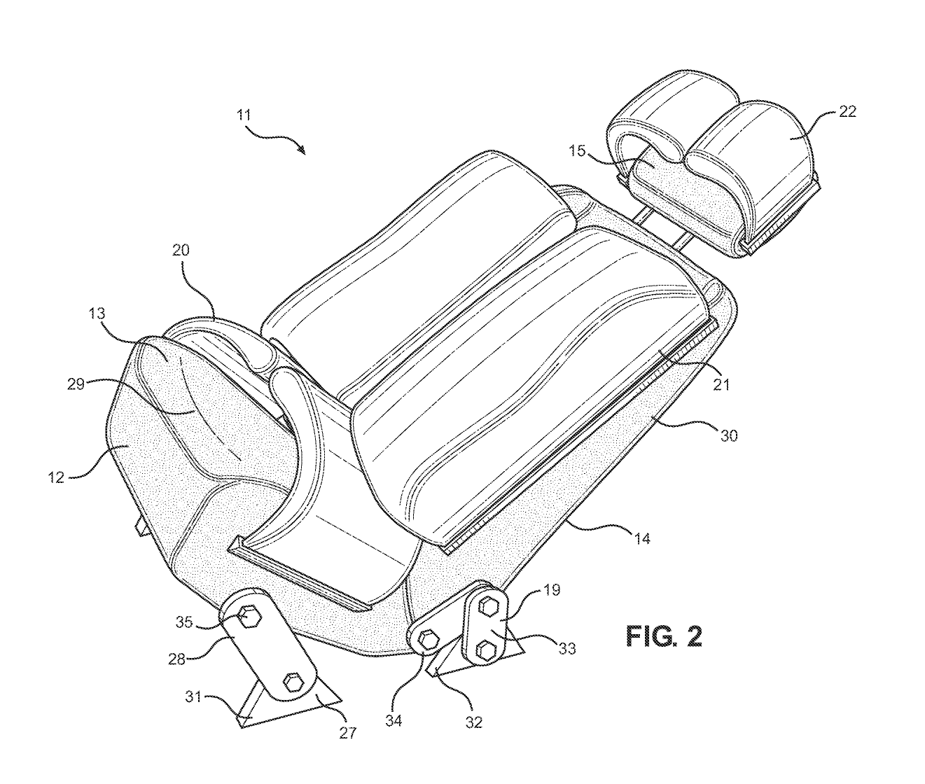

Referring now to FIGS. 1 and 2, there is shown a front view of an embodiment of the vehicle safety seat wherein the seat is in an upright position and the airbags are disposed in a stored configuration and a perspective view of an embodiment of the vehicle safety seat wherein the seat is in a reclined position and the airbags are deployed. The vehicle safety seat 11 comprises a seat 12 having a front side 29, a rear side 30, a seat bottom 13, a backrest 14, and a headrest 15, wherein the seat bottom 13 is adapted to support a user thereon. The backrest 14 is adapted to allow a back of the user to remain in an upright position and the headrest 15 provides a support for the user to rest his or her head thereon. The seat 12 resembles a conventional vehicle seat. The vehicle safety seat 11 further comprises a frame 19 having an upper end pivotally secured to a lower end of the seat 12 and a lower end adapted to be secured to the floor of a vehicle. The vehicle safety seat 11 may be installed in any transportation vehicle, including an automobile, trucks, buses, trains, and aircrafts.

The frame 19 allows the seat 12 to immediately recline upon collision, as a result of the disengagement of a locking mechanism 35, in order to absorb inertial forces resulting from impact with another object. In the illustrated embodiment, the frame 19 comprises a front pair of legs 31 and a rear pair of legs 32, wherein each pair of legs 31, 32 are disposed on opposing sides of the seat 12. The front and rear legs 31, 32 each comprise an anchor 27 disposed at the lower end thereof and adapted to secure the legs 31, 32 to the vehicle via any suitable fastener, such as screws. A bar 28 extends vertically upward from the anchor 27 on the front legs 31 and is pivotally secured between the anchor 27 and a lower end of the seat 12. The rear pair of legs 32 each further comprise a first bar 33 and a second bar 34, wherein a first end of the first bar 33 is pivotally secured to the anchor 27 and a second end thereof is pivotally secured to a first end of the second bar 34. A second end of the second bar 34 is pivotally secured to the lower end of the seat 12. The attachment of the first bar 33 to the second bar 34 enables the rear pair of legs 32 to buckle, allowing the vertical length of the leg 32 to decrease, thereby permitting the rear side 30 of the seat 12 to lower.

The pivoting front and rear pair of legs 31, 32 of the frame 19 allows the seat 12 to move between an upright configuration, for normal driving conditions, to an angled configuration, resulting from a collision. In the upright configuration, the seat bottom 13 is substantially horizontal and the backrest 14 and headrest 15 are substantially vertically disposed in order to allow a user to remain seated as he or she would in a conventional seat. The front and rear pair of legs 31, 32 extend vertically upwards so as to allow the seat 12 to remain in an upright position.

In the angled configuration, the seat 12 is reclined so that the rear side 30 of the seat 12 is lower than the rear side 30 of the seat 12 when disposed at the upright configuration. The bars 28 of the first legs 31 are disposed at an angle so as to allow the seat bottom 13 to tilt backwards. The first 33 and second bar 34 of the rear legs 32 pivot to a collapsed configuration such that the vertical length of the rear leg 32 is decreased in order to allow the rear side 30 of the seat 12 to lower. In some embodiments, the vehicle safety seat 11 comprises a torsion spring operably connected to and secured between the frame 19 and the seat 12, wherein the seat 12 is adapted to rock back and forth in order to further absorb the force of the impact and prevent injuries to the neck and back as a result of the impact.

The vehicle safety seat 11 further comprises a locking mechanism 35 adapted to block the frame 19 from allowing the seat 12 to move to the angled configuration, thereby locking the seat in the upright configuration. The locking mechanism 35 allows the frame to move between the upright and angled configuration and, wherein the locking mechanism 35 is adapted to automatically unlock the frame upon collision and allow the seat 12 to recline. In the illustrated embodiment, the locking mechanism 35 comprises a spring loaded detent hinge incorporated into the pivot points of the bars 28, 33, 34 of the front and rear legs 31, 32 that allows the bars 28, 33, 34 to pivot once the threshold load on the detent is exceeded.

One or more airbags 20, 21, 22 are housed within the seat 12 and are stored in a deflated, compact configuration. The airbags 20, 21, 22 are adapted to deploy in the event of a collision and enclose a user's body in order to protect the user from airborne debris. An airbag 20, 21, 22 is disposed on each opposing lateral side of the seat bottom 13, the backrest 14, and the headrest 15. Each airbag 20, 21, 22 is adapted to deploy from a slot 18 extending from the sides of the seat 12. Once deployed, the airbags 20, 21, 22 comprise an arcuate shape so as to allow the pair of airbags 20, 21, 22 to surround the sides and front of the user's body.

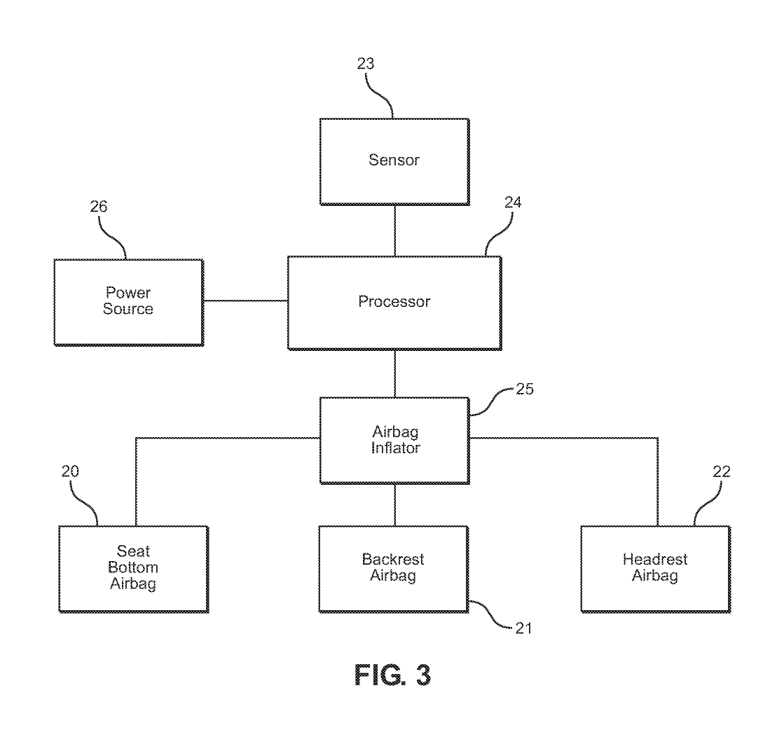

Referring now to FIG. 3, there is shown a diagram of the control circuit of the vehicle safety seat. The vehicle safety seat further comprises one or more crash sensors 23 adapted to be disposed within the vehicle and detect a collision with another object. The crash sensors 23 measure such stimuli as vehicle impact, wheel speed, seat occupant status, brake pressure and impact, and other vehicle status indicators. The sensors 23 are operably connected to a processor 24 which analyzes the measurements of the sensors 23. The processor 24 includes a predetermined threshold measurement for each sensor 23. Preferably, the processor 24 will signal an airbag inflator 25 to deploy the airbags 20, 21, 22 if two or more sensor 23 thresholds are surpassed. For example, the airbags 20, 21, 22 will not deploy unless vehicle impact is detected and the wheel speed sensor 23 indicates that the vehicle is traveling over ten miles per hour. Furthermore, a seat will not deploy airbags 20, 21, 22 unless the sensor 23 measures the weight resting upon the seat and the processor 24 determines an individual is occupying the seat.

The processor 24 is further operably connected to the airbag inflator 25, wherein the inflator 25 is adapted to inflate each of the airbags 20, 21, 22 housed within the seat. Any suitable airbag inflator 25 can be used, such as an inflator adapted to set off a chemical reaction, thereby producing a gas that then fills up the airbags 20, 21, 22. A power source 26 powers the processor 24 and the inflator 25 and is adapted to electronically connect thereto. The power source 26 may be one or more disposable or rechargeable batteries.

The airbags 20, 21, 22 are stored within the seat, and the airbag inflator 25 is also stored therein. When the control circuit determines an accident has occurred, the inflator 25 inflates the airbags 20, 21, 22 and they extend through slots on the sides of the seat. The airbags 20, 21, 22 have an arcuate shape wherein each airbag 20, 21, 22 is adapted to cover roughly half of the user's body. In operation, the crash sensors 23 measure the stimuli and generate a signal, wherein the signal is relayed to the processor 24. If the predetermined thresholds for the sensors 23 are exceeded, the processor 24 signals to the airbag inflator 25 to deploy the airbags 20, 21, 22. The airbags 20 in the seat bottom extend over the lap of a user, the airbags 21 in the backrest extend over the torso and chest of the user, and the airbags 22 disposed in the headrest extend over the head of the user. Thus, the front and side of the user is enclosed by the airbags 20, 21, 22 and protected from airborne debris. In some embodiments, the airbags 20, 21, 22 comprise one or more apertures in order to allow the airbags 20, 21, 22 to deflate once deployed. Further, upon the collision, the seat is automatically reclined backwards due to the frame's response to the force of the impact.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vehicle safety seat, comprising:
a seat having a rear side, a front side, a seat bottom, a backrest, and a headrest, wherein said seat is adapted to be positioned in a vehicle;
one or more sensors for determining a collision between said vehicle and another object, wherein said one or more sensors generate a signal;
one or more airbags stored in said seat in a compact configuration, wherein said one or more airbags are operably connected to an inflator, such that said inflator inflates said one or more airbags, wherein said one or more airbags expand out from said seat to enclose a portion of a user in order to protect said user from airborne debris;
a processor for processing said signal from said one or more sensors and relaying said signal to said inflator;
a control circuit operably connecting said processor to one or more sensors, said airbag inflator, and said one or more airbags, such that said one or more sensors detect vehicle operation and status, and relays said status to said processor, wherein said processor activates said airbag inflator to deploy said one or more airbags when a predetermined threshold is exceeded for said one or more sensors.

2) The vehicle safety seat of claim 1, wherein a pair of said one or more airbags are each disposed on opposing sides of said seat bottom, said backrest, and said headrest such that said one or more airbags are adapted to surround a user seated on said seat.

3) The vehicle safety seat of claim 1, wherein a pair of said one or more airbags are each disposed on opposing sides of said seat bottom of said seat such that said one or more airbags are adapted to surround a legs of said user seated on said seat.

4) The vehicle safety seat of claim 3, wherein upon inflation each of said one or more airbags comprise an arcuate shape.

5) The vehicle safety seat of claim 1, wherein a pair of said one or more airbags are each disposed on opposing sides of said backrest such that said one or more airbags are adapted to surround a torso and chest of said user seated on said seat.

6) The vehicle safety seat of claim 1, wherein a pair of said one or more airbags are each disposed on opposing sides of said headrest such that said one or more airbags are adapted to surround a head of said user seated on said seat.

7) The vehicle safety seat of claim 1, wherein an opposing sides of said bottom of said seat bottom, said backrest, and said headrest each comprise a slot adapted to allow said one or more airbags to deploy therethrough.

8) The vehicle safety seat of claim 1, further comprising a frame pivotally secured to a lower end of said seat and configured to secure to said vehicle, such that said seat is movable between an a upright configuration for normal driving conditions, and an angled configuration as a result of said collision, such that said rear side of said seat is disposed lower in said angled configuration than said rear side of said seat disposed at said upright configuration.

9) The vehicle safety seat of claim 11, wherein said frame comprises a pair of front legs and a pair of rear legs each disposed on a lower end of opposing sides of said seat, wherein said pair of front legs are adapted to pivot and said pair of rear legs are adapted to collapse to a decreased length in order to allow said rear side of said seat to lower and recline.
